(19) United States
(12) Patent Application Publication
(10) Pub. No.: US 2018/0321785 A1
(43) Pub. Date: Nov. 8, 2018

(54) TOUCH POSITION DETECTION METHOD, TOUCH PANEL CONTROLLER, AND ELECTRONIC DEVICE

(71) Applicant: SHARP KABUSHIKI KAISHA, Sakai City, Osaka (JP)

(72) Inventors: MUTSUMI HAMAGUCHI, Sakai City (JP); MASAYUKI MIYAMOTO, Sakai City (JP); SHINJI SHINJO, Sakai City (JP)

(73) Assignee: SHARP KABUSHIKI KAISHA, Sakai City, Osaka (JP)

(21) Appl. No.: 15/773,316

(22) PCT Filed: Sep. 9, 2016
(86) PCT No.: PCT/JP2016/076685

§ 371 Date: May 3, 2018

(30) Foreign Application Priority Data
Nov. 19, 2015 (JP) 2015-226802

(51) Int. Cl. G06F 3/041; G06F 3/044; G02F 1/1333

(52) U.S. Cl. CPC G06F 3/0416; G02F 2201/121; G02F 1/13338; G06F 3/044

(57) ABSTRACT

Capacitance distribution is detected on a touch panel with a simple configuration. Drive sense lines (DS0 to DS(M−1)) are driven at a first potential on the basis of a code sequence. Subsequently, each of drive sense switch elements (DST22 and DST22′) corresponding to a hand-touching region (22) is made to turn off, and a linear sum signal based on an electric charge of each of detection electrodes (E) is read.

### TECHNICAL FIELD

The present invention relates to a touch position detection method using a touch panel that detects a capacitance or a change in capacitance between each of a plurality of electrodes and a detected subject, a touch panel controller, and an electronic device.

### BACKGROUND ART

PTL 1 discloses a capacitance detection method using a touch panel that detects a capacitance or a change in capacitance between each of a plurality of electrodes and a detected subject.

FIG. 12 is a circuit diagram illustrating a configuration of a touch panel system in the prior art. A touch panel 92 includes 12 detection electrodes E arranged in four rows and three columns in matrix with an interval between each other. A sense line S coupled to each of the detection electrodes E is connected to a read circuit 95.

In a capacitance detection method using the touch panel 92 formed as described above, a signal corresponding to an electrostatic capacity between each of the detection electrodes E and a detected subject passes through the corresponding sense line S and is read by the read circuit 95. Then, distribution of the electrostatic capacity or a change in electrostatic capacity on the touch panel 92 is detected.

### CITATION LIST

### Patent Literature

PTL 1: JP 2015-32234 A (published Feb. 16, 2015).

### SUMMARY OF INVENTION

### Technical Problem

However, the above-mentioned prior art illustrated in FIG. 12 needs to install the sense line S from each of all the detection electrodes E of the touch panel 92 to the read circuit 95 in order to detect distribution of an electrostatic capacity or a change in electrostatic capacity on the touch panel 92. Thus, in view of upsizing of the touch panel, a wiring line resistance of the sense line S increases, and the number of channels (the number of sense lines S) of the read circuit 95 increases in proportion to a result of multiplying the number of rows by the number of columns of the detection electrodes E. This leads to a complicated configuration of a touch panel system.

An object of the present invention is to provide a touch position detection method capable of detecting capacitance distribution between each of detection electrodes and a detected subject on a touch panel with a simple configuration, a touch panel controller, and an electronic device.

### Solution to Problem

To solve the above-described problems, a touch position detection method according to one aspect of the present invention is a touch position detection method for detecting a touch position on a touch panel based on a capacitance between each of a plurality of electrodes arranged in matrix on the touch panel and a detected subject. The touch position detection method includes: a first detection step of detecting a hand-touching region being a region in which a hand is placed for input to the touch panel and input is unintentional; a first drive step of turning on a switch element selected among a plurality of switch elements between the plurality of electrodes and a plurality of signal lines aligned in a first direction of the matrix based on a code sequence via a plurality of control lines aligned in a second direction intersecting the first direction and driving the plurality of signal lines at a first potential; and a second detection step of, after the first drive step, turning off a switch element corresponding to the hand-touching region detected in the first detection step among the plurality of switch elements and also turning on a switch element except for the switch element corresponding to the hand-touching region, reading a linear sum signal based on an electric charge of each of the plurality of electrodes along each of the plurality of signal lines, and detecting a touch position in which input to the touch panel is intentional.

To solve the above-described problems, a touch panel controller according to one aspect of the present invention is a touch panel controller configured to control a touch panel configured to detect a touch position based on a capacitance between each of a plurality of electrodes arranged in matrix and a detected subject. The touch panel controller includes: a detection circuit configured to detect a hand-touching region being a region in which a hand is placed for input to the touch panel and input is unintentional; and a drive circuit configured to turn on a switch element selected among a plurality of switch elements between the plurality of electrodes and a plurality of signal lines aligned in a first direction of the matrix based on a code sequence via a plurality of control lines aligned in a second direction intersecting the first direction and drive the plurality of signal lines at a first potential. The detection circuit reads a linear sum signal based on an electric charge of each of the plurality of electrodes along each of the plurality of signal lines while a switch element corresponding to the hand-touching region detected by the detection circuit among the plurality of switch elements is made to turn off and a switch element except for the switch element corresponding to the hand-touching region is also made to turn on, and detects a touch position in which input to the touch panel is intentional.

To solve the above-described problems, an electronic device according to one aspect of the present invention includes the touch panel controller of the present invention.

### Advantageous Effects of Invention

According to each of the aspects of the present invention, an effect capable of detecting capacitance distribution between each of detection electrodes and a detected subject on a touch panel with a simple configuration is achieved.

### BRIEF DESCRIPTION OF DRAWINGS

FIG. 1 is a circuit diagram illustrating a configuration of a touch panel system according to a first embodiment.

FIGS. 2A and 2B illustrate an example of a drive code of a drive circuit of a touch panel controller provided in the touch panel system. FIG. 2A illustrates an example of a drive code driving at two values of +1/−1 and a decoding code. FIG. 2B illustrates an example of a drive code driving at only +1 and a decoding code.

FIGS. 3A to 3C are diagrams for describing a method for reading a difference between a linear sum signal along one of drive sense lines of a touch panel provided in the touch panel system and a linear sum signal along another one of the drive sense lines. FIG. 3A illustrates an example of reading a difference between the drive sense lines adjacent to each other (next to each other). FIG. 3B illustrates an example of reading a difference between the drive sense lines with one line therebetween. FIG. 3C illustrates an example of reading a difference between the drive sense lines with three lines therebetween.

FIG. 4 is a graph showing capacitance distribution between a detection electrode corresponding to each of the drive sense lines and a detected subject.

FIG. 5 is a diagram for describing a method for reading a difference between a linear sum signal based on a group including the plurality of drive sense lines and another linear sum signal based on another group including the other plurality of drive sense lines.

FIG. 6 is a circuit diagram illustrating a configuration of a touch panel system according to a second embodiment.

FIG. 7 is a diagram illustrating an example of a drive code of a drive circuit of a touch panel controller provided in the touch panel system.

FIGS. 8A and 8B are diagrams illustrating an example of another drive code of the drive circuit.

FIG. 9 is a circuit diagram illustrating a configuration of a touch panel system according to a third embodiment.

FIG. 10 is a block diagram illustrating a configuration of an electronic device according to a fourth embodiment.

FIG. 11 is a diagram for describing an example of a relationship between arrangement of electrodes and a region in which some contact with a touch panel is occurring.

FIG. 12 is a circuit diagram illustrating a configuration of a touch panel system in the prior art.

### DESCRIPTION OF EMBODIMENTS

A detailed description follows regarding embodiments of the present invention.

### First Embodiment

### Configuration of Touch Panel System 1

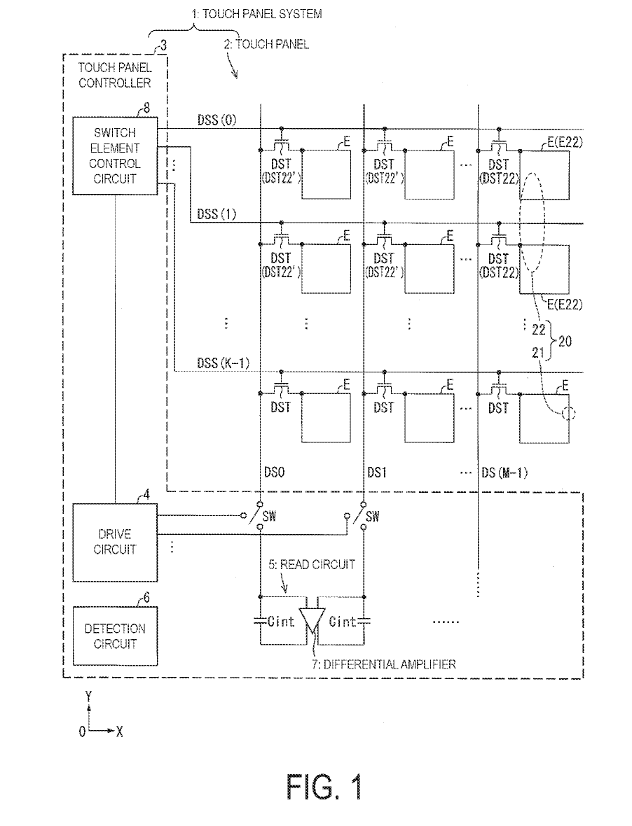

FIG. 1 is a circuit diagram illustrating a configuration of a touch panel system 1 according to a first embodiment. The touch panel system 1 includes a touch panel 2 and a touch panel controller 3 that controls the touch panel 2.

The touch panel 2 includes K (where K is plural) control lines DSS(0) to DSS(K−1) (control lines) and M (where M is plural) drive sense lines DS0 to DS(M−1) (signal lines) intersecting each other. The touch panel 2 also includes (K×M) detection electrodes E (electrodes) that correspond to intersections of the K control lines DSS(0) to DSS(K−1) and the M drive sense lines DS0 to DS(M−1) and that are arranged in matrix. Each of the detection electrodes E is disposed on the touch panel 2.

A drive sense switch element DST (switch element) is formed between each of the detection electrodes E and the corresponding drive sense line. The drive sense switch element DST is formed of a transistor. A gate of each of the drive sense switch elements DST is coupled to the corresponding control line.

The touch panel 2 is provided for detecting a capacitance or a change in capacitance between each of the detection electrodes E and a detected subject such as a finger and a pen.

The touch panel controller 3 includes a drive circuit 4 connected to the M drive sense lines DS0 to DS(M−1) via switching switches SW, a switch element control circuit 8 connected to the K control lines DSS(0) to DSS(K−1), a plurality of read circuits 5 connected to the drive sense lines adjacent to each other, and a detection circuit 6 that detects a capacitance or a change in capacitance between each of the detection electrodes E and the detected subject on the basis of an output of each of the read circuits 5.

Each of the read circuits 5 includes a differential amplifier 7 that amplifies a difference between outputs of the drive sense lines adjacent to each other and a pair of integral capacitances Cint provided between one input and one output of the differential amplifier 7 and between another input and another output thereof. Note that each of the read circuits 5 may include a switch that short-circuits one terminal and the other terminal of the integral capacitances Cint and resets a state of the differential amplifier 7 (not illustrated).

### Action of Touch Panel System 1

The touch panel system 1 formed as described above works as follows.

First, the switch element control circuit 8 turns on the drive sense switch element DST selected among the (K×M) drive sense switch elements DST on the basis of a factor “1” of a code sequence of K rows and N columns via the K control lines DSS(0) to DSS(K−1). At this time, the drive sense switch elements DST that are not selected are off. The switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with +V (for example, power source voltage) through the selected drive sense switch element DST (first preparatory drive step).

Next, the switch element control circuit 8 turns on the drive sense switch element DST selected among the (K×M) drive sense switch elements DST on the basis of a factor “−1” of the code sequence of K rows and N columns via the K control lines DSS(0) to DSS(K−1). At this time, the drive sense switch elements DST that are not selected are off. Herein, the switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with −V (for example, ground voltage) through the selected drive sense switch element DST (second preparatory drive step).

Next, the switch element control circuit 8 turns off the (K×M) drive sense switch elements DST via the K control lines DSS(0) to DSS(K−1) and brings each of the detection electrodes E into a floating state. The switching switches SW also switch in such a way to connect the read circuits 5 and the M drive sense lines DS0 to DS(M−1).

Subsequently, the switch element control circuit 8 turns on the (K×M) drive sense switch elements DST via the K control lines DSS(0) to DSS(K−1). Each of the read circuits 5 amplifies a difference between linear sum signals based on an electric charge of each of the detection electrodes E read along the adjacent drive sense line via the drive sense switch element DST turning on. Next, the detection circuit 6 detects a capacitance or a change in capacitance between each of the detection electrodes E of the touch panel 2 and a detected subject on the basis of a sum-of-product computation performed on the difference between the linear sum signals output from each of the read circuits 5 and the code sequence (preparatory detection step).

In the touch panel system 1, unintentional contact with the touch panel 2 may occur. A region in which the unintentional contact occurs is referred to as a hand-touching region being a region in which a hand is placed for input to the touch panel and input is unintentional. The above-described detection circuit 6 detects the hand-touching region in which the unintentional contact occurs. A detection result in the hand-touching region may become a noise component. The touch panel system 1 further works as follows to prevent a decrease in detection accuracy of a position of the detected subject on the touch panel 2 due to the noise component.

First, the switch element control circuit 8 turns on the drive sense switch element DST selected among the (K×M) drive sense switch elements DST on the basis of a factor “1” of a code sequence of K rows and N columns via the K control lines DSS(0) to DSS(K−1). At this time, the drive sense switch elements DST that are not selected are off. The switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with +V (for example, power source voltage) through the selected drive sense switch element DST (first drive step).

Next, the switch element control circuit 8 turns on the drive sense switch element DST selected among the (K×M) drive sense switch elements DST on the basis of a factor “−1” of the code sequence of K rows and N columns via the K control lines DSS(O) to DSS(K−1). At this time, the drive sense switch elements DST that are not selected are off. Then, the drive circuit 4 drives the M drive sense lines DS0 to DS(M−1) and charges each of the detection electrodes E with −V (for example, ground voltage) through the selected drive sense switch element DST (second drive step).

Next, the switch element control circuit 8 turns off the (K×M) drive sense switch elements DST via the K control lines DSS(0) to DSS(K−1) and brings each of the detection electrodes E into a floating state. The switching switches SW also switch in such a way to connect the read circuits 5 and the M drive sense lines DS0 to DS(M−1).

Subsequently, the switch element control circuit 8 turns off a switch coupled to the control line corresponding to the hand-touching region detected by the detection circuit 6 among the (K×M) drive sense switch elements DST via the K control lines DSS(0) to DSS(K−1), and also turns on a switch except for the switch coupled to the control line corresponding to the hand-touching region.

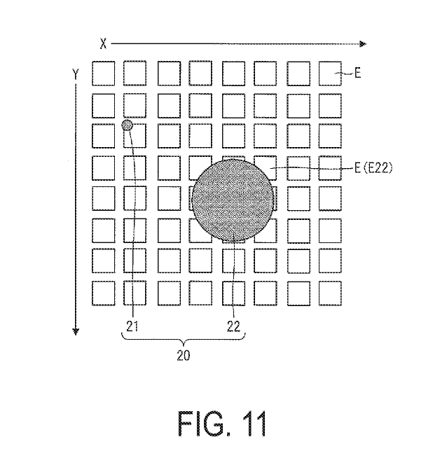

A specific technique for determining selection or non-selection of each of the (K×M) drive sense switch elements DST according to the hand-touching region detected by the detection circuit 6 is described with reference to FIGS. 1 and 11. FIG. 11 is a diagram for describing an example of a relationship between arrangement of the detection electrodes E and a region 20 including all regions in which some contact with the touch panel 2 is occurring.

The region 20 is distributed above each of the detection electrodes E and/or a vicinity of each of the detection electrodes E. The region 20 includes a touch region 21 being a region corresponding to contact (with the intention of input to the touch panel 2) of a detected subject with the touch panel 2 and a hand-touching region 22 being a region corresponding to unintentional contact with the touch panel 2. As described above, the hand-touching region 22 is a region in which a hand is placed for input to the touch panel 2 and input is unintentional.

Herein, an area of the hand-touching region 22 tends to be significantly greater than an area of the touch region 21. In other words, in a case where an area of the hand-touching region 22 is greater than or equal to a predetermined area (however, the predetermined area is, for example, 30 mm long×30 mm wide), the hand-touching region 22 can be easily identified as a region corresponding to unintentional contact with the touch panel 2 (first detection step). Note that at this time, an electrode directly below the hand-touching region 22 (electrode corresponding to the hand-touching region) among the detection electrodes E is a detection electrode E22.

In a case where the region 20 and the detection electrode E22 are detected by the detection circuit 6 as illustrated in FIG. 1 in the touch panel system 1, the switch element control circuit 8 selects a drive sense switch element (switch corresponding to the hand-touching region) DST22 connected to the detection electrode E22 among the (K×M) drive sense switch elements DST and turns off the selected drive sense switch element DST22.

Note that a gate of each of the drive sense switch elements DST22 is coupled to a control line DSS(0) or DSS(1) in the touch panel system 1, but, at this time, a gate of each of drive sense switch elements DST22′ is also coupled to the control line DSS(0) or DSS(1). Therefore, in a case where each of the drive sense switch elements DST22 is made to turn off via the control line DSS(0) and DSS(1), each of the drive sense switch elements DST22′ is also made to turn off. In other words, at this time, each of the drive sense switch elements DST22′ is also selected by the switch element control circuit 8.

On the other hand, the (K×M) drive sense switch elements DST except for the drive sense switch elements DST22 and DST22′ are not selected by the switch element control circuit 8 and are thus made to turn on.

Each of the read circuits 5 amplifies a difference between linear sum signals based on an electric charge of each of the detection electrodes E read along the adjacent drive sense line via the drive sense switch element DST turning on. Next, the detection circuit 6 detects a capacitance or a change in capacitance between each of the detection electrodes E of the touch panel 2 and a detected subject on the basis of a sum-of-product computation performed on the difference between the linear sum signals output from each of the read circuits 5 and the code sequence. Subsequently, the detection circuit 6 detects a position (namely, touch position) of the detected subject on the touch panel 2 on the basis of the detected capacitance or the detected change in capacitance (second detection step).

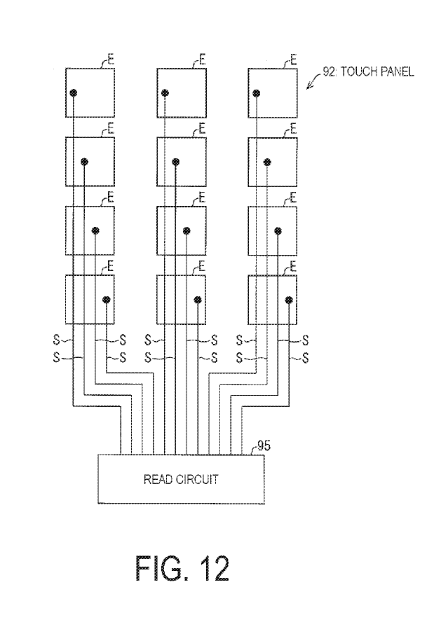

In the above-described touch panel 92 in the prior art with reference to FIG. 12, the number of channels (the number of sense lines S) of the read circuit 95 is massive, so that in sequential drive, the greater number of sense lines S increases time required for scanning or the same scanning time reduces the number of sense lines S that can be scanned. However, in a case where the touch panel 2 in which each of the detection electrodes E is provided with the drive sense switch element DST and the switching switch SW as in the first embodiment is driven in parallel, the touch panel can be scanned in a short time with a simple configuration.

If the touch panel 2 is driven in parallel, it is also more advantageous in terms of an S/N ratio than the sequential drive.

In recent years, a reduction in size of a liquid crystal module typified by a structure, which is called in-cell, including a sensor of a touch panel formed inside a display panel has been advancing, and a distance between a liquid crystal panel and the touch panel has been reduced. Thus, an influence of noise by the touch panel on the liquid crystal panel has not been negligible, and, for example, the touch panel and the liquid crystal panel have been conceivably driven in a time-division manner. Consequently, drive time assigned to the touch panel is limited, so that driving the touch panel in parallel is more advantageous than the sequential drive.

For the in-cell, the touch panel and the liquid crystal panel are integrally produced in the step of producing the liquid crystal panel, and thus the drive sense switch element DST of the touch panel 2 is easily installed in the touch panel 2. In other words, the transistor forming the drive sense switch element DST can be produced with the same mask as a mask for the liquid crystal panel, so that an increase in cost of an initial investment is reduced even in a case where the drive sense switch element DST is provided in the touch panel.

Furthermore, the plurality of detection electrodes E arranged in matrix in the touch panel 2 may also be used as common electrodes of the liquid crystal panel. For example, as described above, when the touch panel and the liquid crystal panel are driven in the time-division manner, a voltage for driving the touch panel is applied to the plurality of detection electrodes E in a drive period assigned to the touch panel, and the detection electrodes E function as electrodes for driving the liquid crystal panel in a drive period assigned to the liquid crystal panel.

In addition to the description above, a capacitance or a change in capacitance due to unintentional contact with the touch panel 2 can be excluded from factors for detecting a position of the detected subject on the touch panel 2 in the touch panel system 1. Therefore, a decrease in detection accuracy of the position of the detected subject on the touch panel 2 can be prevented in the touch panel system 1. In other words, an influence of (great) noise coming in from hand-touching (having great capacity coupling) can be suppressed in the touch panel system 1.

### Specific Example of Code Sequence

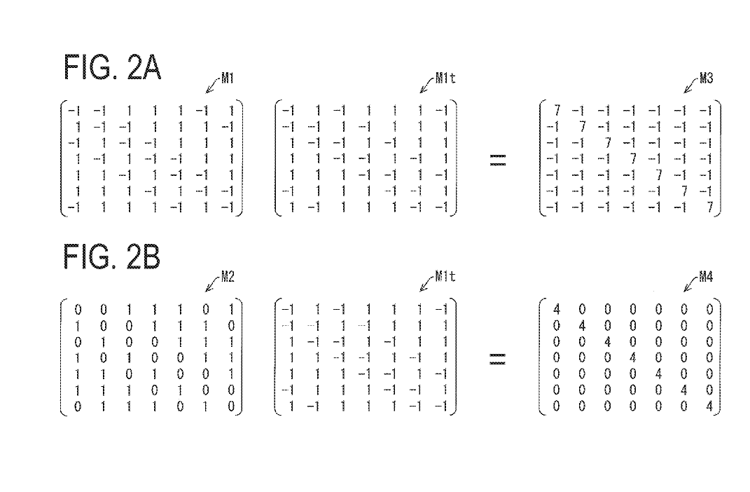

FIGS. 2A and 2B illustrate an example of a drive code (code sequence) of the drive circuit 4 of the touch panel controller 3 provided in the touch panel system 1. FIG. 2A illustrates an example of a drive code driving at two values of +1/−1 and a decoding code. FIG. 2B illustrates an example of a drive code driving at only +1 and a decoding code.

With reference to FIG. 2A, a code sequence M1 of an M sequence for driving seven control lines DSS(0) to DSS(K−1) at two values of “+1” and “−1” by the switch element control circuit 8, a code sequence M1t used for a sum-of-product computation with a linear sum signal for decoding the detection circuit 6 and formed by transposing the code sequence M1, and a code sequence M3 being a result of the sum-of-product computation performed on the code sequence M1 and the code sequence M1t are illustrated.

With reference to FIG. 2B, a code sequence M2 for driving control lines DSS(0) to DSS(6) at only “+1” by the switch element control circuit 8, the code sequence M1t used for a sum-of-product computation with a linear sum signal for decoding in the detection circuit 6 and formed by transposing the code sequence M1, and a code sequence M4 being a result of the sum-of-product computation performed on the code sequence M2 and the code sequence M1t are illustrated.

### Specific Example of Differential Reading

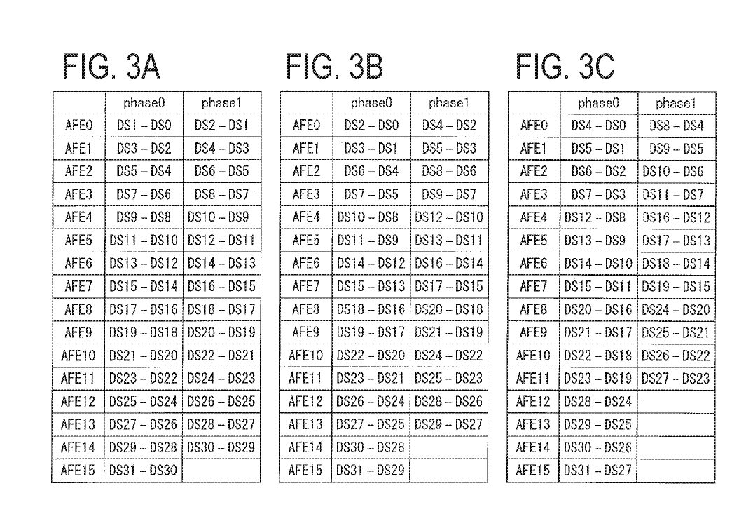

FIGS. 3A to 3C are diagrams for describing a method for reading a difference between a linear sum signal along one of the drive sense lines of the touch panel 2 provided in the touch panel system 1 and a linear sum signal along another one of the drive sense lines. FIG. 3A illustrates an example of reading a difference between the drive sense lines adjacent to each other (next to each other). FIG. 3B illustrates an example of reading a difference between the drive sense lines with one line therebetween. FIG. 3C illustrates an example of reading a difference between the drive sense lines with three lines therebetween.

With reference to FIG. 3A, an example of reading 32 drive sense lines DS0 to DS31 by 16 read circuits AFE0 to AFE15 is illustrated. The read circuits AFE0 to AFE15 each have the same configuration as that of the read circuit 5.

First, at a timing phase 0, the read circuit AFE0 amplifies a difference between a linear sum signal from the drive sense line DS1 and a linear sum signal from the drive sense line DS0. Then, the read circuit AFE1 amplifies a difference between the drive sense line DS3 and the drive sense line DS2, and the read circuit AFE2 amplifies a difference between the drive sense line DS5 and the drive sense line DS4. Hereinafter, the read circuits AFE3 to AFE15 similarly amplify a difference between the adjacent drive sense lines.

At a next timing phase 1, the read circuit AFE0 amplifies a difference between the drive sense line DS2 and the drive sense line DS1. Then, the read circuit AFE1 amplifies a difference between the drive sense line DS4 and the drive sense line DS3, and the read circuit AFE2 amplifies a difference between the drive sense line DS6 and the drive sense line DS5. Hereinafter, the read circuits AFE3 to AFE14 similarly amplify a difference between the adjacent drive sense lines.

In the example illustrated in FIGS. 1 and 3A, the example in which the read circuit differentially amplifies the adjacent drive sense lines is illustrated. However, the present invention is not limited thereto. The sense lines that are not adjacent to each other with a plurality of lines therebetween may be differentially amplified.

FIG. 3B illustrates an example of reading a difference between the drive sense lines with one line therebetween.

First, at a timing phase 0, the read circuit AFE0 amplifies a difference between the drive sense line DS2 and the drive sense line DS0. Then, the read circuit AFE1 amplifies a difference between the drive sense line DS3 and the drive sense line DS1, and the read circuit AFE2 amplifies a difference between the drive sense line DS6 and the drive sense line DS4. Hereinafter, the read circuits AFE3 to AFE15 similarly amplify a difference between the drive sense lines with one line therebetween.

At a next timing phase 1, the read circuit AFE0 amplifies a difference between the drive sense line DS4 and the drive sense line DS2. Then, the read circuit AFE1 amplifies a difference between the drive sense line DSS and the drive sense line DS3, and the read circuit AFE2 amplifies a difference between the drive sense line DS8 and the drive sense line DS6. Hereinafter, the read circuits AFE3 to AFE13 similarly amplify a difference between the drive sense lines with one line therebetween.

FIG. 3C illustrates an example of reading a difference between the drive sense lines with three lines therebetween.

First, at a timing phase 0, the read circuit AFE0 amplifies a difference between the drive sense line DS4 and the drive sense line DS0. Then, the read circuit AFE1 amplifies a difference between the drive sense line DS5 and the drive sense line DS1, and the read circuit AFE2 amplifies a difference between the drive sense line DS6 and the drive sense line DS2. Hereinafter, the read circuits AFE3 to AFE15 similarly amplify a difference between the drive sense lines with three lines therebetween.

At a next timing phase 1, the read circuit AFE0 amplifies a difference between the drive sense line DS8 and the drive sense line DS4. Then, the read circuit AFE1 amplifies a difference between the drive sense line DS9 and the drive sense line DS5, and the read circuit AFE2 amplifies a difference between the drive sense line DS10 and the drive sense line DS6. Hereinafter, the read circuits AFE3 to AFE11 similarly amplify a difference between the drive sense lines with three lines therebetween.

By such differential reading that reads a difference between the drive sense lines, noise on one of the drive sense lines and noise on the other drive sense line can cancel each other by subtraction, so that the touch panel system resistant to noise can be formed.

A difference is read between the drive sense lines in the differential reading, which results in a decreased value of a read signal. Thus, the differential reading is advantageous in that a gain of the differential amplifier 7 can be increased more than a gain in a case of single reading.

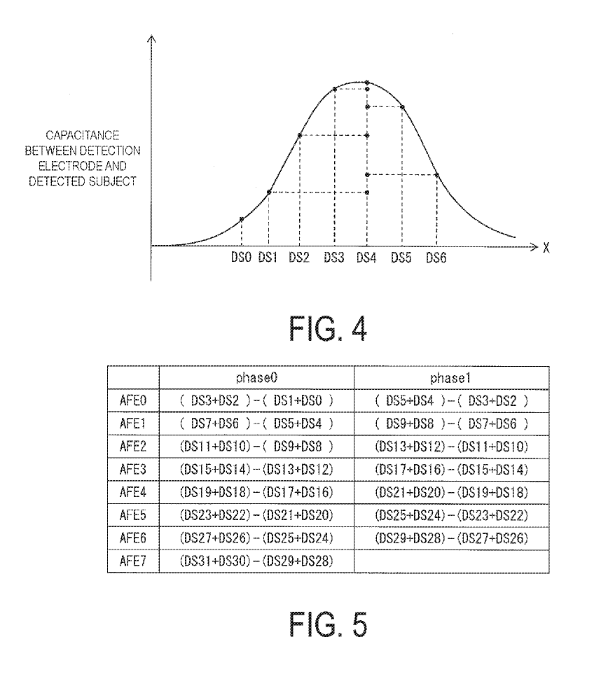

FIG. 4 is a graph showing capacitance distribution between the detection electrode E corresponding to each of the drive sense lines and a detected subject.

In a hover operation operated by a detected subject such as a finger slightly away from the touch panel 2, distribution of a capacitance between the detection electrode E and the detected subject in a plane direction of the touch panel 2 is distribution as shown in FIG. 4.

A signal in which a difference between linear sum signals from the adjacent drive sense lines is amplified has a small value, but an obtained value of the differential signal can be increased as shown in FIG. 4 by positioning the drive sense lines having a difference amplified away from each other as illustrated in FIGS. 3B and 3C.

FIG. 5 is a diagram for describing a method for reading a difference between a linear sum signal based on a group including the plurality of drive sense lines and another linear sum signal based on another group including the other plurality of drive sense lines.

The above-mentioned embodiment illustrates the example of reading a difference between the linear sum signal along one of the drive sense lines and the other linear sum signal along the other drive sense line. However, the present invention is not limited thereto. A difference may be read between a linear sum signal based on a group including the plurality of drive sense lines and another linear sum signal based on another group including the other plurality of drive sense lines.

FIG. 5 illustrates an example of making a group of a (2n)^{th} drive sense line and a (2n+1)^{th} drive sense line and reading a difference between grouped drive sense line groups.

First, at a timing phase 0, the drive sense lines DS3 and DS2 are formed into a group, and the drive sense lines DS1 and DS0 are formed into a group. Then, the read circuit AFE0 amplifies a difference between a sum of a linear sum signal from the drive sense line DS3 and a linear sum signal from the drive sense line DS2 and a sum of a linear sum signal from the drive sense line DS1 and a linear sum signal from the drive sense line DS0. The drive sense lines DS7 and DS6 are formed into a group, and the drive sense lines DS5 and DS4 are formed into a group. Then, the read circuit AFE1 amplifies a difference between a sum of a linear sum signal from the drive sense line DS7 and a linear sum signal from the drive sense line DS6 and a sum of a linear sum signal from the drive sense line DS5 and a linear sum signal from the drive sense line DS4. The drive sense lines DS11 and DS10 are formed into a group, and the drive sense lines DS9 and DS8 are formed into a group. Then, the read circuit AFE2 amplifies a difference between a sum of the drive sense line DS11 and the drive sense line DS10 and a sum of the drive sense line DS9 and the drive sense line DS8. Hereinafter, the read circuits AFE3 to AFE7 similarly amplify a difference between the grouped drive sense line groups.

At a next timing phase 1, the drive sense lines DS5 and DS4 are formed into a group, and the drive sense lines DS3 and DS2 are formed into a group. Then, the read circuit AFE0 amplifies a difference between a sum of a linear sum signal from the drive sense line DS5 and a linear sum signal from the drive sense line DS4 and a sum of a linear sum signal from the drive sense line DS3 and a linear sum signal from the drive sense line DS2. The drive sense lines DS9 and DS8 are formed into a group, and the drive sense lines DS7 and DS6 are formed into a group. Then, the read circuit AFE1 amplifies a difference between a sum of a linear sum signal from the drive sense line DS9 and a linear sum signal from the drive sense line DS8 and a sum of a linear sum signal from the drive sense line DS7 and a linear sum signal from the drive sense line DS6. The drive sense lines DS13 and DS12 are formed into a group, and the drive sense lines DS11 and DS10 are formed into a group. Then, the read circuit AFE2 amplifies a difference between a sum of the drive sense line DS13 and the drive sense line DS12 and a sum of the drive sense line DS11 and the drive sense line DS10. Hereinafter, the read circuits AFE3 to AFE6 similarly amplify a difference between the grouped drive sense line groups.

The differential reading reads a difference component between the drive sense lines, so that only a small signal can be acquired. However, as described above, the drive sense lines are brought together into a group and then read, so that a signal component read from the drive sense lines can be increased.

Note that the above-mentioned embodiment illustrates the example of turning on the drive sense switch elements DST via all the control lines DSS(0) to DSS(K−1) and driving the drive sense lines DS0 to DS(M−1), but the present invention is not limited thereto. The switch element control circuit 8, the drive circuit 4, and the switching switches SW may form so as to turn on the drive sense switch elements DST for at least two of the control lines and drive the drive sense lines DS0 to DS(M−1).

### Second Embodiment

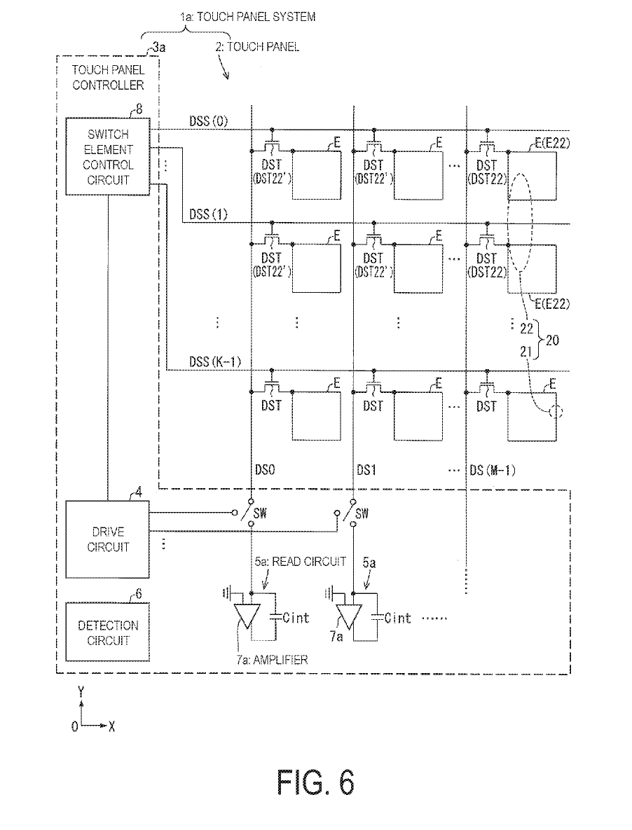

A description follows regarding another embodiment of the present invention, with reference to FIGS. 6 to 8. Note that members having the same function as the members stated in the embodiment above are appended with the same reference signs for the sake of description, and the description thereof is omitted.

FIG. 6 is a circuit diagram illustrating a configuration of a touch panel system 1a according to a second embodiment. The touch panel system 1a performs single reading on a drive sense line.

The touch panel system 1a includes a touch panel 2 and a touch panel controller 3a that controls the touch panel 2. The touch panel controller 3a includes M read circuits 5a. Each of M drive sense lines DS0 to DS(M−1) is connected to one of inputs of an amplifier 7a of the corresponding read circuit Sa. Another input of the amplifier 7a is AC grounded. An integral capacitance Cint is connected between the one input and an output of the amplifier 7a. Note that each of the read circuits 5a may include a switch that short-circuits one terminal and the other terminal of the integral capacitance Cint and resets a state of the amplifier 7a (not illustrated).

The single reading reads an absolute value of a capacitance instead of a difference component of a capacitance. Thus, the single reading is advantageous in that a value of a linear sum signal is greater than that in the differential reading, but the amplifier is more likely to be saturated.

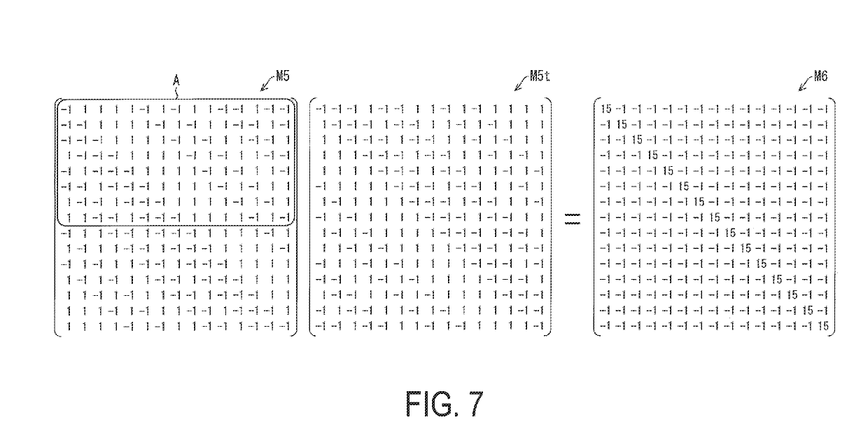

FIG. 7 is a diagram illustrating an example of a drive code (code sequence) of a drive circuit 4 of the touch panel controller 3a provided in the touch panel system 1a.

FIG. 7 illustrates a code sequence M5 of 15 rows and 15 columns of an M sequence when driving at two values of a factor “+1” for allowing the drive circuit 4 to drive the drive sense line from a reference potential to a power source potential and a factor “−1” for allowing the drive circuit 4 to drive the drive sense line from a reference potential to a ground potential, a code sequence M5t used for a sum-of-product computation for decoding in a detection circuit 6 and formed by transposing the code sequence M5, and a code sequence M6 being a result of the sum-of-product computation performed on the code sequence M5 and the code sequence M5t.

Eight control lines are driven on the basis of a code sequence A of eight rows and 15 columns surrounded by a frame illustrated in FIG. 7 in the code sequence M5.

The number of the factor “1” is three and the number of the factor “−1” is five in a first column from the left in the code sequence A, and thus a difference between them in number is two. The number of the factor “1” is three and the number of the factor “−1” is five in a second column to a third column similarly from the left, and thus a difference between them in number is two. The number of the factor “1” is four and the number of the factor “−1” is four in a fourth column from the left, and thus there is no difference between them in number. The number of the factor “1” is six and the number of the factor “−1” is two in a ninth column to a tenth column from the left, and thus a difference between them in number is four.

In this way, a difference between the number of the factor “1” and the number of the factor “−1” in each of the columns in the code sequence A varies from zero to four and is unbalanced.

On the other hand, in the code sequence M1 of the M sequence of seven rows and seven columns described above with FIG. 2A, the number of the factor “1” is four and the number of the factor “−1” is three in each of the first column to the seventh column, and thus a difference between them in number is one. Therefore, the code sequence M1 always has mostly good balance between the number of the factor “1” and the number of the factor “−1”. Note that the most balanced state is when the number of the factor “1” and the number of the factor “−1” are the same and a difference between them in number is zero.

Because the code sequence M1 has the seven rows and the seven columns, all of the eight drive sense lines cannot be driven at the same time. However, in a case where the balance between the number of the factor “1” and the number of the factor “−1” in the code sequence is prioritized, there is such an option that the seven drive sense lines DS0 to DS6 are driven by the code sequence M1 at the first timing to obtain capacitance distribution corresponding to the drive sense lines DS0 to DS6, the seven drive sense lines DS1 to DS7 are then driven by the code sequence M1 at the next timing to obtain capacitance distribution corresponding to the drive sense lines DS1 to DS7, and both of the capacitance distributions are combined together to obtain capacitance distribution corresponding to the eight drive sense lines DS0 to DS7.

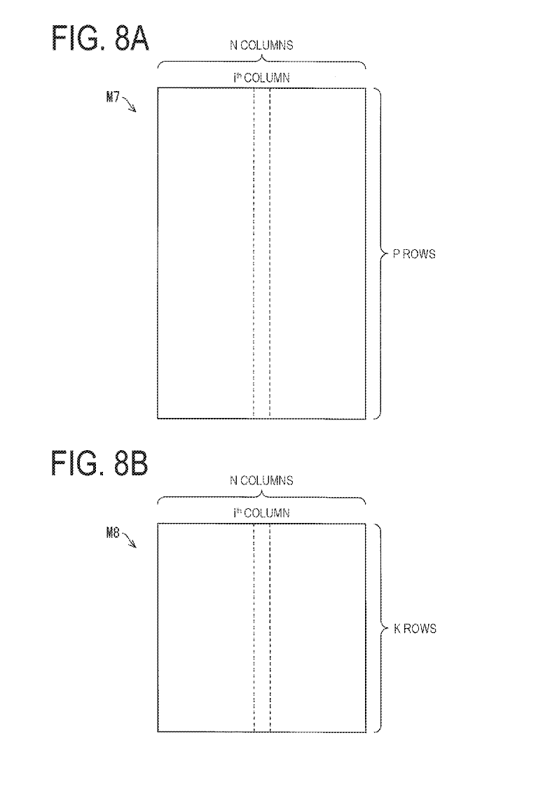

FIGS. 8A and 8B are diagrams illustrating an example of another drive code of a switch element control circuit 8.

A code sequence M8 includes K rows selected from P rows in a code sequence M7 of P rows and N columns including the factor “1” for driving the drive sense line from a reference potential to a power source potential and the factor “−1” for driving the sense line from a reference potential to a ground potential (K≤N, K≤P), and is balanced such that a difference between the number of the factor “1” and the number of the factor “−1” in an i^{th} column (1≤i≤N) in the code sequence is brought closer to zero. On the basis of the code sequence M8, the switch element control circuit 8 drives K control lines DSS(0) to DSS(K−1). Also in this way, the control lines can be balanced and driven.

For example, when 16 control lines are driven, the 16 control lines are driven by using the code sequence M8 having 16 rows selected from the code sequence M7 of the M sequence of 64 rows and 64 columns such that a difference between the number of the factor “1” and the number of the factor “−1” in an i^{th} column (1≤i≤N) is brought closer to zero and is balanced. Thus, the control lines can be balanced and driven.

### Third Embodiment

### Configuration of Touch Panel System 1b

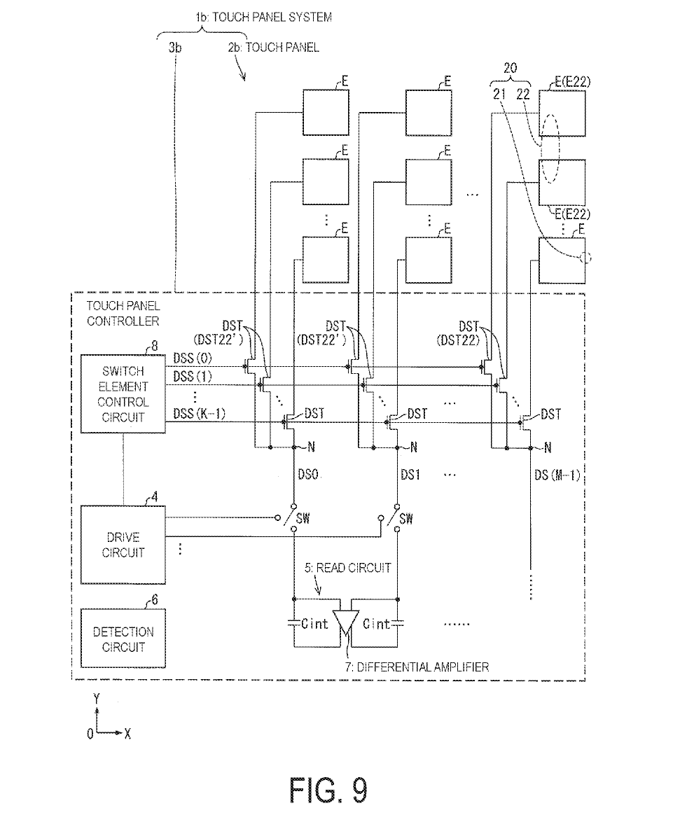

FIG. 9 is a circuit diagram illustrating a configuration of a touch panel system 1b according to a third embodiment of the present invention. Members having the same function as the members stated in the embodiment above are appended with the same reference signs, and the description thereof is omitted. The touch panel system 1b includes a touch panel 2b and a touch panel controller 3b that controls the touch panel 2b.

The touch panel 2b includes (K×M) detection electrodes E (electrodes) arranged in matrix. Herein, an X-axis direction is a first direction of this matrix. A Y-axis direction is a second direction intersecting the first direction of this matrix.

The touch panel controller 3b includes a drive circuit 4 connected to M drive sense lines DS0 to DS(M−1) via switching switches SW, a switch element control circuit 8 connected to K control lines DSS(0) to DSS(K−1), a plurality of read circuits 5 connected to the drive sense lines adjacent to each other, a detection circuit 6 that detects a capacitance or a change in capacitance between each of the detection electrodes E and a detected subject on the basis of an output of each of the read circuits 5, and a drive sense switch element DST (switch element).

Each of the read circuits 5 includes a differential amplifier 7 that amplifies a difference between outputs of the drive sense lines adjacent to each other and a pair of integral capacitances Cint provided between one input and one output of the differential amplifier 7 and between another input and another output thereof. Note that each of the read circuits 5 may include a switch that short-circuits one terminal and the other terminal of the integral capacitances Cint and resets a state of the differential amplifier 7 (not illustrated).

The drive sense lines DS0 to DS(M−1) are aligned in the X-axis direction. The plurality of detection electrodes E aligned in one line in the Y direction are connected to a node N via the drive sense switch elements DST and connected to one corresponding drive sense line via the node N.

The control lines DSS(0) to DSS(K−1) are aligned in the Y direction. Gates of the plurality of drive sense switch elements DST connected to the plurality of detection electrodes E aligned in one line in the X direction are connected to one corresponding control line.

The touch panel 2b differs from the touch panel 2 in that the touch panel 2b does not include the switch element DST built therein. The touch panel controller 3b differs from the touch panel controllers 3, 3a in that the touch panel controller 3b includes the switch element DST built therein.

### Action of Touch Panel System 1b

The touch panel system 1b formed as described above works as follows.

First, the switch element control circuit 8 turns on the drive sense switch element DST selected among the (K×M) drive sense switch elements DST on the basis of a factor “1” of a code sequence of K rows and N columns via the K control lines DSS(0) to DSS(K−1). At this time, the drive sense switch elements DST that are not selected are off. The switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with +V (for example, power source voltage) through the selected drive sense switch element DST (first preparatory drive step).

Next, the switch element control circuit 8 turns on the drive sense switch element DST selected among the (K×M) drive sense switch elements DST on the basis of a factor “−1” of the code sequence of K rows and N columns via the K control lines DSS(0) to DSS(K−1). At this time, the drive sense switch elements DST that are not selected are off. Herein, the switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with −V (for example, ground voltage) through the selected drive sense switch element DST (second preparatory drive step).

Next, the switch element control circuit 8 turns off the (K×M) drive sense switch elements DST via the K control lines DSS(0) to DSS(K−1) and brings each of the detection electrodes E into a floating state. The switching switches SW also switch in such a way to connect the read circuits 5 and the M drive sense lines DS0 to DS(M−1). Subsequently, the switch element control circuit 8 turns on the (K×M) drive sense switch elements DST via the K control lines DSS(0) to DSS(K−1).

Each of the read circuits 5 amplifies a difference between linear sum signals based on an electric charge of each of the detection electrodes E read along the adjacent drive sense line via the drive sense switch element DST turning on. Next, the detection circuit 6 detects a capacitance or a change in capacitance between each of the detection electrodes E of the touch panel 2b and a detected subject on the basis of a sum-of-product calculation of the difference between the linear sum signals output from each of the read circuits 5 and the code sequence (preparatory drive step and first detection step).

Then, the switch element control circuit 8 turns on the drive sense switch element DST selected among the (K×M) drive sense switch elements DST on the basis of a factor “1” of the code sequence of K rows and N columns via the K control lines DSS(0) to DSS(K−1). At this time, the drive sense switch elements DST that are not selected are off. The switching switches SW also switch in such a way to connect the drive circuit 4 and the M drive sense lines DS0 to DS(M−1). Then, the drive circuit 4 drives the M drive sense lines DS0 to DS(M−1) and charges each of the detection electrodes E with +V (for example, power source voltage) through the selected drive sense switch element DST (first drive step).

Next, the switch element control circuit 8 turns on the drive sense switch element DST selected among the (K×M) drive sense switch elements DST on the basis of a factor “−1” of the code sequence of K rows and N columns via the K control lines DSS(0) to DSS(K−1). At this time, the drive sense switch elements DST that are not selected are off. Then, the drive circuit 4 drives the M drive sense lines DS0 to DS(M−1) and charges each of the detection electrodes E with −V (for example, ground voltage) through the selected drive sense switch element DST (second drive step).

Next, the switch element control circuit 8 turns off the (K×M) drive sense switch elements DST via the K control lines DSS(0) to DSS(K−1) and brings each of the detection electrodes E into a floating state. The switching switches SW also switch in such a way to connect the read circuits 5 and the M drive sense lines DS0 to DS(M−1).

Subsequently, the switch element control circuit 8 turns off a switch selected according to the known capacitance or the known change in capacitance among the (K×M) drive sense switch elements DST via the K control lines DSS(0) to DSS(K−1), and also turns on a switch that is not selected.

A specific technique for determining selection or non-selection of each of the (K×M) drive sense switch elements DST according to the known capacitance or the known change in capacitance is the same as that in the touch panel system 1 illustrated in FIG. 1.

In other words, the switch element control circuit 8 selects the drive sense switch element DST22 and the drive sense switch element DST22′ connected to the same control line as that of the drive sense switch element DST22 among the (K×M) drive sense switch elements DST, and turns off the drive sense switch elements DST22 and DST22′. On the other hand, the (K×M) drive sense switch elements DST except for the drive sense switch elements DST22 and DST22′ are not selected by the switch element control circuit 8 and are thus made to turn on.

Note that the switch element control circuit 8 may control each of the drive sense switch elements DST individually in the touch panel system 1b. In this case, each of the drive sense switch elements DST22′ may be non-selected (ON).

Each of the read circuits 5 amplifies a difference between linear sum signals based on an electric charge of each of the detection electrodes E read along the adjacent drive sense line via the drive sense switch element DST turning on. Next, the detection circuit 6 detects a capacitance or a change in capacitance between each of the detection electrodes E of the touch panel 2b and a detected subject on the basis of a sum-of-product computation performed on the difference between the linear sum signals output from each of the read circuits 5 and the code sequence. Subsequently, the detection circuit 6 detects a position (namely, touch position) of the detected subject on the touch panel 2b on the basis of the detected capacitance or the detected change in capacitance (second detection step).

The touch panel controller 3b can detect capacitance distribution between each of the detection electrodes E and the detected subject on the touch panel 2b with a simple configuration even in the passive touch panel 2b that does not include the drive sense switch element DST built therein. Furthermore, the touch panel controller 3b is more advantageous than the touch panel controller in the touch panel system in the prior art illustrated in FIG. 12 in that the touch panel controller 3b can read a linear sum signal based on an electric charge of each of the detection electrodes E in parallel along a signal line.

In addition to the description above, a capacitance or a change in capacitance due to unintentional contact with the touch panel 2b can be excluded from factors for detecting a position of the detected subject on the touch panel 2b in the touch panel system 1b. Therefore, a decrease in detection accuracy of a position of the detected subject on the touch panel 2b can be prevented in the touch panel system 1b.

### Fourth Embodiment

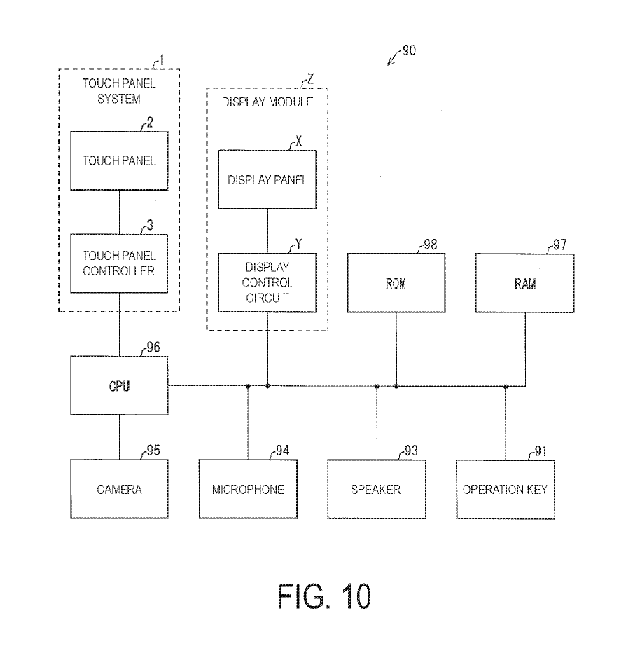

FIG. 10 is a block diagram illustrating a configuration of a portable telephone 90 (electronic device) according to a fourth embodiment of the present invention. Members having the same function as the members stated in the embodiment above are appended with the same reference signs for the sake of description, and the description thereof is omitted.

The portable telephone 90 includes a CPU 96, a RAM 97, a ROM 98, a camera 95, a microphone 94, a speaker 93, an operation key 91, a display module Z including a display panel X and a display control circuit Y, and a touch panel system 1. Each of the components is connected to one another with a data bus.

The CPU 96 controls action of the portable telephone 90. The CPU 96 executes a program stored in the ROM 98, for example. The operation key 91 receives an input of an instruction by a user of the portable telephone 90. The RAM 97 stores data generated by execution of a program by the CPU 96 or data input via the operation key 91 in a volatile manner. The ROM 98 stores data in a non-volatile manner.

The ROM 98 is a ROM that enables writing and erasing, such as an erasable programmable read-only memory (EPROM) and a flash memory. Note that the portable telephone 90 may include an interface (IF) for connection to another electronic device with a wire, which is not illustrated in FIG. 10.

The camera 95 captures an object in response to an operation of the operation key 91 by a user. Note that image data of the captured object is stored in the RAM 97 and an external memory (for example, a memory card). The microphone 94 receives an input of a voice of a user. The portable telephone 90 digitizes the input voice (analog data). The portable telephone 90 then transmits the digitized voice to the other end of communication (for example, another portable telephone). The speaker 93 outputs a sound based on music data stored in the RAM 97, for example.

The touch panel system 1 includes a touch panel 2 and a touch panel controller 3. The CPU 96 controls action of the touch panel system 1. The CPU 96 executes a program stored in the ROM 98, for example. The RAM 97 stores data generated by execution of a program by the CPU 96 in a volatile manner. The ROM 98 stores data in a non-volatile manner.

The display panel X displays an image stored in the ROM 98 and the RAM 97 by the display control circuit Y. The display panel X overlaps the touch panel 2 or includes the touch panel 2 built therein. The touch panel system 1 may be the touch panel system 1a according to the second embodiment or the touch panel system 1b according to the third embodiment.

### Supplement

A touch position detection method according to aspect 1 of the present invention is a touch position detection method for detecting a touch position on a touch panel based on a capacitance between each of a plurality of electrodes (detection electrodes E) arranged in matrix on the touch panel and a detected subject. The touch position detection method includes: a first detection step of detecting a hand-touching region being a region in which a hand is placed for input to the touch panel and input is unintentional; a first drive step of turning on a switch element selected among a plurality of switch elements (drive sense switch elements DST) between the plurality of electrodes and a plurality of signal lines (drive sense lines DS0 to DS(M−1)) aligned in a first direction of the matrix based on a code sequence via a plurality of control lines (control lines DSS(0) to DSS(K−1)) aligned in a second direction intersecting the first direction and driving the plurality of signal lines at a first potential; and a second detection step of, after the first drive step, turning off a switch element (drive sense switch elements DST22 and DST22′) corresponding to the hand-touching region detected in the first detection step among the plurality of switch elements and also turning on a switch element except for the switch element corresponding to the hand-touching region, reading a linear sum signal based on an electric charge of each of the plurality of electrodes along each of the plurality of signal lines, and detecting a touch position in which input to the touch panel is intentional.

According to the configuration above, the switch element selected among the plurality of switch elements turns on, and the plurality of signal lines are driven on the basis of the code sequence. Then, the plurality of switch elements turn on, and a linear sum signal based on an electric charge of each of the electrodes is read along each of the signal lines. As a result, capacitance distribution between each of detection electrodes and the detected subject on a touch panel can be detected with a simple configuration.

According to the configuration above, the capacitance corresponding to the hand-touching region can be excluded from factors for detecting a position of the detected subject on the touch panel. Therefore, according to the configuration above, a decrease in detection accuracy of the position of the detected subject on the touch panel due to the capacitance corresponding to the hand-touching region can be prevented. In other words, according to the configuration above, an influence of (great) noise coming in from hand-touching (having great capacity coupling) can be suppressed.

Preferably, the touch position detection method according to aspect 2 of the present invention in aspect 1 further includes, after the first drive step, a second drive step of turning on another switch element selected among the plurality of switch elements on the basis of the code sequence via the control line and driving the plurality of signal lines at a second potential different from the first potential. The second detection step is preferably performed after the second drive step.

According to the configuration above, the switch element selected in the first drive step on the basis of the code sequence can be charged at the first potential, and the other switch element selected in the second drive step on the basis of the code sequence can be discharged at the second potential.

In the touch position detection method according to aspect 3 of the present invention in aspect 1 or 2, the switch element (drive sense switch elements DST22 and DST22′) coupled to the control line corresponding to the hand-touching region is preferably made to turn off in the second detection step.

According to the configuration above, the capacitance corresponding to the hand-touching region can be excluded from factors for detecting a position of the detected subject on the touch panel with a simpler configuration.

In the capacitance detection method according to aspect 4 of the present invention in any one of aspects 1 to 3, the plurality of electrodes and the plurality of switch elements are preferably formed in the touch panel.

According to the configuration above, the transistor forming the switch element can be produced with the same mask as that for the liquid crystal panel, thereby making it easy to form the touch panel integrally with the liquid crystal panel.

In the touch position detection method according to aspect 5 of the present invention in any one of aspects 1 to 3, the plurality of electrodes are preferably formed in the touch panel, and the plurality of switch elements are preferably formed in a touch panel controller configured to control the touch panel.

According to the configuration above, the plurality of switch elements are formed in the touch panel controller, thereby simplifying the configuration of the touch panel.

In the touch position detection method according to aspect 6 of the present invention in any one of aspects 1 to 5, the first detection step preferably includes a first preparatory drive step of turning on a switch element selected among the plurality of switch elements based on the code sequence via the control line and driving the plurality of signal lines at a first potential, and a preparatory detection step of, after the first preparatory drive step, turning on all of the plurality of switch elements, reading a linear sum signal based on an electric charge of each of the plurality of electrodes along each of the plurality of signal lines, and detecting the hand-touching region.

According to the configuration above, as the first detection step, the switch element selected among the plurality of switch elements is made to turn on, and the plurality of signal lines are driven on the basis of the code sequence. Then, as the first detection step, the plurality of switch elements are made to turn on, and a linear sum signal based on an electric charge of each of the electrodes is read along each of the signal lines. As a result, the hand-touching region can be detected with a simple configuration.

Preferably, the touch position detection method according to aspect 7 of the present invention in aspect 6 further includes, after the first preparatory drive step, a second preparatory drive step of turning on another switch element selected among the plurality of switch elements, based on the code sequence via the control line and driving the plurality of signal lines at a second potential different from the first potential. The preparatory detection step is preferably performed after the second preparatory drive step.

According to the configuration above, the switch element selected in the first preparatory drive step on the basis of the code sequence can be charged at the first potential, and the other switch element selected in the second preparatory drive step on the basis of the code sequence can be discharged at the second potential.

A touch panel controller according to aspect 8 of the present invention is a touch panel controller configured to control a touch panel configured to detect a touch position based on a capacitance between each of a plurality of electrodes (detection electrodes E) arranged in matrix and a detected subject. The touch panel controller includes: a detection circuit configured to detect a hand-touching region being a region in which a hand is placed for input to the touch panel and input is unintentional; and a drive circuit configured to turn on a switch element selected among a plurality of switch elements (drive sense switch elements DST) between the plurality of electrodes and a plurality of signal lines (drive sense lines DS0 to DS(M−1)) aligned in a first direction of the matrix based on a code sequence via a plurality of control lines (control lines DSS(0) to DSS(K−1)) aligned in a second direction intersecting the first direction and drive the plurality of signal lines at a first potential. The detection circuit reads a linear sum signal based on an electric charge of each of the plurality of electrodes along each of the plurality of signal lines while a switch element (drive sense switch elements DST22 and DST22′) corresponding to the hand-touching region detected by the detection circuit among the plurality of switch elements is made to turn off and a switch element except for the switch element corresponding to the hand-touching region is also made to turn on, and detects a touch position in which input to the touch panel is intentional.

In the touch panel controller according to aspect 9 of the present invention in aspect 8, the touch panel is preferably provided on a display surface of a liquid crystal panel, and the plurality of electrodes are preferably used as common electrodes of the liquid crystal panel.

The configuration above simplifies a configuration of an in-cell liquid crystal panel in which a touch panel is installed.

An electronic device according to aspect 10 of the present invention includes the touch panel controller in aspect 8 or 9.

The electronic device according to aspect 11 of the present invention in aspect 10 preferably includes a liquid crystal panel.

The present invention is not limited to each of the embodiments stated above, and various modifications may be implemented within a range not departing from the scope of the claims. Embodiments obtained by appropriately combining technical approaches stated in each of the different embodiments also fall within the scope of the technology of the present invention. Moreover, novel technical features may be formed by combining the technical approaches stated in each of the embodiments.

### REFERENCE SIGNS LIST

1, 1a, 1b Touch panel system
2, 2b Touch panel
3, 3a, 3b Touch panel controller
4 Drive circuit
5, 5a Read circuit
6 Detection circuit
7 Differential amplifier
7a Amplifier
8 Switch element control circuit
22 Hand-touching region
90 Portable telephone (electronic device)
DS0 to DS(M−1) Drive sense line (signal line)
DSS(0) to DSS(K−1) Control line (control line)
DST, DST22, DST22′ Drive sense switch element (switch element)
E, E22 Detection electrode (electrode)

1. A touch position detection method for detecting a touch position on a touch panel based on a capacitance between each of a plurality of electrodes arranged in matrix on the touch panel and a detected subject, the touch position detection method comprising:
a first detection step of detecting a hand-touching region being a region in which a hand is placed for input to the touch panel and input is unintentional;
a first drive step of turning on a switch element selected among a plurality of switch elements between the plurality of electrodes and a plurality of signal lines aligned in a first direction of the matrix based on a code sequence via a plurality of control lines aligned in a second direction intersecting the first direction and driving the plurality of signal lines at a first potential; and
a second detection step of, after the first drive step, turning off a switch element corresponding to the hand-touching region detected in the first detection step among the plurality of switch elements and also turning on a switch element except for the switch element corresponding to the hand-touching region, reading a linear sum signal based on an electric charge of each of the plurality of electrodes along each of the plurality of signal lines, and detecting a touch position in which input to the touch panel is intentional.

2. The touch position detection method according to claim 1,
wherein a switch element coupled to the control line corresponding to the hand-touching region is made to turn off in the second detection step.

3. The touch position detection method according to claim 1,
wherein the plurality of electrodes and the plurality of switch elements are formed in the touch panel.

4. The touch position detection method according to claim 1,
wherein the plurality of electrodes are formed in the touch panel, and
the plurality of switch elements are formed in a touch panel controller configured to control the touch panel.

5. The touch position detection method according to claim 1,
wherein the first detection step includes
a first preparatory drive step of turning on a switch element selected among the plurality of switch elements based on the code sequence via the control line and driving the plurality of signal lines at a first potential, and
a preparatory detection step of, after the first preparatory drive step, turning on all of the plurality of switch elements, reading a linear sum signal based on an electric charge of each of the plurality of electrodes along each of the plurality of signal lines, and detecting the hand-touching region.

6. A touch panel controller configured to control a touch panel configured to detect a touch position based on a capacitance between each of a plurality of electrodes arranged in matrix and a detected subject, the touch panel controller comprising:
a detection circuit configured to detect a hand-touching region being a region in which a hand is placed for input to the touch panel and input is unintentional; and
a drive circuit configured to turn on a switch element selected among a plurality of switch elements between the plurality of electrodes and a plurality of signal lines aligned in a first direction of the matrix based on a code sequence via a plurality of control lines aligned in a second direction intersecting the first direction and drive the plurality of signal lines at a first potential,
wherein the detection circuit reads a linear sum signal based on an electric charge of each of the plurality of electrodes along each of the plurality of signal lines while a switch element corresponding to the hand-touching region detected by the detection circuit among the plurality of switch elements is made to turn off and a switch element except for the switch element corresponding to the hand-touching region is also made to turn on, and detects a touch position in which input to the touch panel is intentional.

7. The touch panel controller according to claim 6,
wherein the touch panel is provided on a display surface of a liquid crystal panel, and
the plurality of electrodes are used as common electrodes of the liquid crystal panel.

8. An electronic device comprising the touch panel controller according to claim 6.
